(19) United States
(12) Patent Application Publication
(10) Pub. No.: US 2003/0014687 A1
(43) Pub. Date: Jan. 16, 2003

(54) Nonvolatile memory unit comprising a control circuit and a plurality of partially defective flash memory devices

(75) Inventor: Chwan-Chia Wu, Taipei (TW)

Correspondence Address: Cooper & Dunham LLP, 1185 Avenue of the Americas, New York, NY, 10036, US

(73) Assignee: Grandex International Corporation

(21) Appl. No.: 09/902,200

(22) Filed: Jul. 10, 2001

(51) Int. Cl. G06F 11/16

(52) U.S. Cl. 714/7

(57) ABSTRACT

The specification discloses a circuit that repairs flash memory faults by reconfiguring memory with symmetric and complementary fault areas and the method for the same. The method can reconfigure faulty flash memory devices so as to use the memory available. It employs a switching controller to determine the beginning and finishing time when data is read out from the flash memory and executes data line reconfiguration during the time the data is read out. The method then can use flash memory with symmetric and complementary fault areas.

### BACKGROUND OF THE INVENTION

1. Field of Invention

The present invention relates to a method that repairs flash memory faults by reconfiguring memory with symmetric and complementary fault areas. In particular, the invention relates to a method that reconfigures data I/O lines during the period data is read out when data storage areas are defective, symmetric and complementary so that the defective flash memory can be reused.

2. Related Art

Due to the nonvolatile and online rewriteable properties of flash memory, flash memory is particularly useful in data storage for portable digital electronics. Examples include file storage, image storage and audio recording. Therefore, flash memory can be applied to personal digital assistants (PDAs), digital cameras, digital cassette recorders, global positioning systems (GPSs), set-up boxes, mobile phones, etc.

Although flash memory is a very convenient device in many applications, its manufacturing process may unavoidably produce defective items. Analyzing lots of defective flash memory situations, one would find that aside from very few seriously damaged situations, most damage is localized within a certain region of the memory array for data storage or even only one bit has a fault. In these cases, discarding the whole flash memory is a waste.

In view of the foregoing, people are looking for a method that can remove the faults or defects in flash memory and make the flash memory useable again so as to lower the cost. To date, methods for repairing memory defects only repair random access memory (RAM) defects, such as the one disclosed in the R.O.C. Pat. No. 213,522, “Method of reusing defective RAM”.

However, since flash memory has a different structure from that of RAM, the method in the previously mentioned patent cannot be applied to the reuse of defective flash memory. The usual RAM separates control lines, address lines and data lines from one another. The previously cited invention uses a multitask selection method to separate defective bit lines in two RAM devices from the external data bus. That is, it uses a multitask method to reconfigure the data lines in the defective RAM by collecting useable data bits to form a complete RAM data access function. However, in addition to the control signals on the control lines, the read/write actions in flash memory also receive different commands to achieve different read/write functions. Although flash memory can be categorized as a NAND/AND type or a NOR type depending on the structure, both of them need external controllers to transmit commands and data through data lines (or I/O lines) from the viewpoint of interfaces to the exterior. (In fact, the NAND/AND type has either a NAND structure or an AND structure, but they share similar characters. For the convenience of explanation, we will call both of them the NAND type.) The only difference is that the NOR type flash memory has independent address lines to transmit read/write addresses and the NAND type flash memory does not have independent address lines. The address input of the NAND type flash memory is transmitted via its data lines. Therefore, if one separates defective bit lines from the data lines as in the previously described technique, a portion of the command transmission will be blocked. If the flash memory is the NAND type memory, a portion of the address transmission will be blocked too. This will result in the controlled flash memory's being unable to receive complete commands (and addresses) and function.

The invention “Method of reusing local defective memory” as disclosed in R.O.C. Pat. No. 278,183 proposes a method that collects several local defective RAM devices to form a good memory device or to remove the local defective area (the faulty sector) in a single memory device for the usage of secondary memory (the good sector). However, this method still does not solve the problems that the flash memory control commands and shared data line transmission have to face as previously described. Therefore, even though that patent claims that the method can be applied to flash memory, it is, in fact, impossible.

The U.S. Pat. No. 5,469,390 “Semiconductor memory system with the function of the replacement of the other chips” uses a fully functioning spare memory chip and a control circuit to mend defective areas distributed in all memory chips. The data to be saved in the defective addresses is then written to the spare memory chip. One feature of the patent is that the spare memory chip is used to storage addresses. Therefore, if some bit lines in the memory array of one memory chip are out of order, the whole chip is considered to be out of order. So the patent is really limited in its applications. Other inventions with similar concepts include U.S. Pat. No. 5,758,056, “Memory system having defective address identification and replacement”, U.S. Pat. No. 5,996,096, “Dynamic redundancy for random access memory assemblies” and R.O.C. Pat. No. 320,795, “Method of reusing defective RAM”.

The above listed patents have a common feature, namely, they all need a memory element with no fault as its spare data storage device. Regardless of the details, these patents basically are only applicable to the situation where independent control lines are used for data transmission. They are not applicable to the reuse of defective flash memory. Furthermore, though U.S. Pat. No. 5,200,959, “Device and method for defect handling in semiconductor memory” provides a solution to the handling of nonvolatile semiconductor memory defects for EEPROM and flash EEPROM, the actual usable storage capacity of the whole memory system varies as the memory defect ratio differs. On the other hand, that patent uses a row address or a column address as its basic unit for removing faults; it is nevertheless not applicable to the situation where the whole row of bit lines is out of order.

### SUMMARY OF THE INVENTION

An objective of the current invention is to provide an effective method of removing defects in flash memory so the flash memory can be used. In view of the special structure of flash memory, particularly its interface to the exterior, the disclosed method reconfigures a memory array when many memory units are out of order and the defective areas are symmetric and commentary. The method performs reconfiguration on the data lines of the flash memory when the data is read out.

In addition, flash memory has more complicated read/write operations than RAM and does not have the nearly standard read/write commands and operations of RAM. Flash memory made by different manufacturers and even different models of flash memory made by the same manufacturer may have different read/write commands and operations.

Another objective of the invention is to provide a control circuit that can be applied to flash memory of many different manufacturers and help implement the disclosed method to use flash memory with defects.

The main technical means to achieve the foregoing objectives is to reconfigure the data lines for flash memory with symmetric and complementary defective areas when data is read out to use the memory.

### BRIEF DESCRIPTION OF THE DRAWINGS

FIG. 1A schematically shows a memory array with a fault in a column;

FIG. 1B schematically shows a memory array with faults in two rows;

FIGS. 2A through 2C schematically show faults in partitioned areas;

FIG. 3A is a schematic diagram showing left-right complementary faults;

FIG. 3B is a schematic diagram showing top-bottom symmetric faults;

FIG. 4 is a system block diagram of the invention;

FIGS. 5A through 5D show examples of various symmetric and complementary defective areas;

FIG. 6 is a selection table for one flash memory unit in the four symmetric and complementary defective areas in FIG. 5;

FIG. 7 is a block diagram of a preferred embodiment of a circuit of the invention;

FIG. 8 is a timing diagram showing an asynchronously controlled reading action according to a preferred embodiment of the invention;

FIG. 9 is a timing diagram showing a synchronously controlled reading action according to a preferred embodiment of the invention; and

FIG. 10 is a command table in a preferred embodiment of the invention showing information relating to commands, controls, addresses and data for different brands and models of flash memory.

### DETAILED DESCRIPTION OF THE INVENTION

The main functions of usual semiconductor memory include data reading and writing. To achieve the goals, semiconductor memory often needs externally provided control signals or commands to ensure the normal reading and writing operations. At the same moment, it needs memory addresses to read out or write in data. Of course, it also needs a proper channel to transmit data. The conventional dynamic random access memory (DRAM) or static random access memory (SRAM) have an independent control bus, address bus and data bus to transmit control signals, addresses and data. Due to the different internal structure, flash memory is categorized as NOR type or NAND type. The NOR type flash memory uses data lines to transmit commands and data and uses address lines to transmit data access addresses. The NAND flash memory uses data lines to transmit all the commands, addresses and data. For either type of flash memory, the character of using data lines to transmit commands for controlling memory reading and writing actions is different from that of using independent reading/writing control lines to give reading/writing control commands in random access memory (RAM). Furthermore, there are more complicated types of reading/writing actions in flash memory than in RAM. Therefore, the conventional fault reconfiguration method to separate data lines for RAM is not applicable to flash memory, for if one simply separates some data lines and does not use them, it is impossible to provide complete commands to the flash memory.

Consistent with the characteristic that both commands and data share the same data lines in flash memory, the present invention thus provides a method to reconfigure defective flash memory and a control switching device for this method, achieving the goal of using defective flash memory.

Apart from the situation where electronic characters run out of normal ranges, common functional faults include stuck at faults, address decoder faults and bridging faults. If the areas where the usual functional faults occur are localized within a certain range, it is then possible to replace the defective areas through the reconfiguration of memory arrays and to use the data stored in faultless areas only. Regardless of the reasons for the functional faults, logically a defective memory area can always be divided into one or several defective areas. The memory arrays outside the defective areas are faultless areas. Theoretically, the faultless areas in the memory array can still store data.

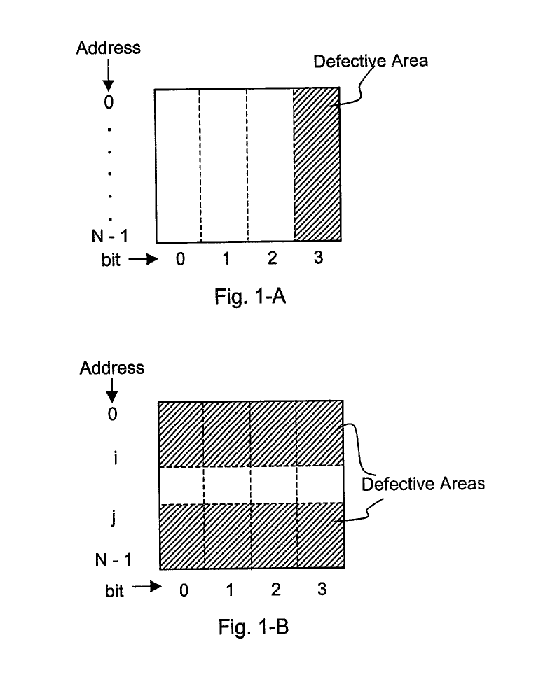

FIGS. 1A and 1B show two distributions of defective areas. In FIG. 1A, the memory is composed of an N×4 memory array, where 2ⁿ and n are positive integers. [NOTE(2/20): Where are “2ⁿ and n” used? There is no formula with these variables.] The address space in this memory array runs from 0 to N−1. That is, there are N sets of 4-bit data units. In the figure, the defective area is localized in the shaded area in bit 3. There may be one or several defective memory cells in the column, or maybe all the N memory cells in bit 3 are out of order. The reasons for such a fault distribution may be stuck at faults or bridging faults. No matter what reasons there are, the memory array shown in FIG. 1A means that data can be stored in bits 0, 1, and 2. Obviously, one needs to look for another column of faultless memory cells to substitute for the defective bit 3 so as to recover the storage capacity of the original N×4 memory array.

FIG. 1B indicates that faults occur in two block areas ranging from address 0 to address i and from address j to address N−1, respectively. The reasons for such faults may be stuck at faults, bridging faults or possibly address decoder faults. Similarly, no matter what the reason, FIG. 1B means that the usable memory space in the whole N×4 memory array is restricted to the area between address (i+1) to address j−1). If one wants to have the storage capacity of a complete N×4 memory array, he has to search for an (N−j+i+1)×4 memory array to replace the two defective areas.

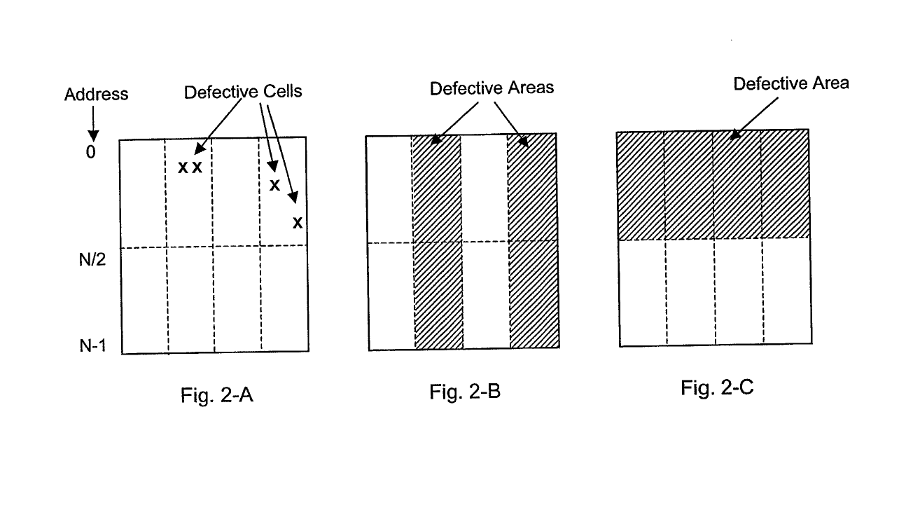

The division of defective areas can have different results depending on different needs. For example, the faults in FIG. 2A can be viewed as the faults in FIG. 2B or those in FIG. 2C.

In view of the interface structure with flash memory commands and data sharing the same data lines, the invention provides a method that reconfigures several symmetric and complementary defective areas in the same type of flash memory to form a complete flash memory data storage space. In accordance with this method, a fairly simple switching circuit applicable to different brands of flash memory can be designed to implement the disclosed method.

To more clearly explain the concept and spirit of the invention, two complementary defective flash memory devices are used for illustration. In practice, one can expand them into several or a set of complementary defective flash memory devices to perform fault removal and reconfiguration.

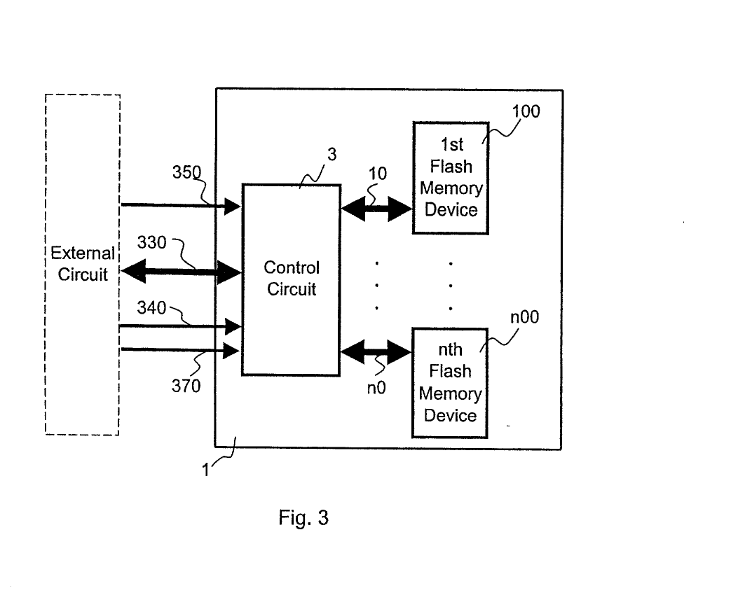

First, the complementary properties of the defective areas are defined as follows. In the two defective flash memory units 100, 200 shown in FIG. 3A, one of them 100 has a fault at bit 3 and the other 200 has faults in bits 0, 1, and 2. Obviously, the fault and faultless areas of the two flash memory units 100, 200 are complementary to each other. Therefore, they are called complementary faults. When the faults in the two flash memory units 100, 200 are complementary, it is fairly easy to perform data storage area substitution. Thus, the defective area (bit 3) in the flash memory unit 100 can be replaced by the faultless area (bit 3) in the other flash memory unit 200. That is, data is normally written to the two flash memory units 100, 200 without worrying where the faults are. On the other hand, data is read out from both of the flash memory. However, a proper switching mechanism is employed to keep the data stored in bits 0, 1, and 2 of the flash memory unit 100 and bit 3 of the flash memory unit 200.

For the convenience of illustration, we call FIG. 3A a left-right complementary type and FIG. 3B a top-bottom symmetry type. In the top-bottom symmetry type in FIG. 3B, the defective areas in the flash memory 100 can be replaced by the non-defective areas in the other flash memory 200. Data is still written into the two flash memory units 100, 200 in the normal way. When reading, data is read out from the flash memory units 100, 200 at the same time. However, one needs to switch among the addresses being read out. If the data being read out belongs to the faultless areas in the flash memory unit 100, the switching device switches to the flash memory unit 100 and data is sent out. Otherwise, the switching device switches to flash memory unit 200 to read out the data.

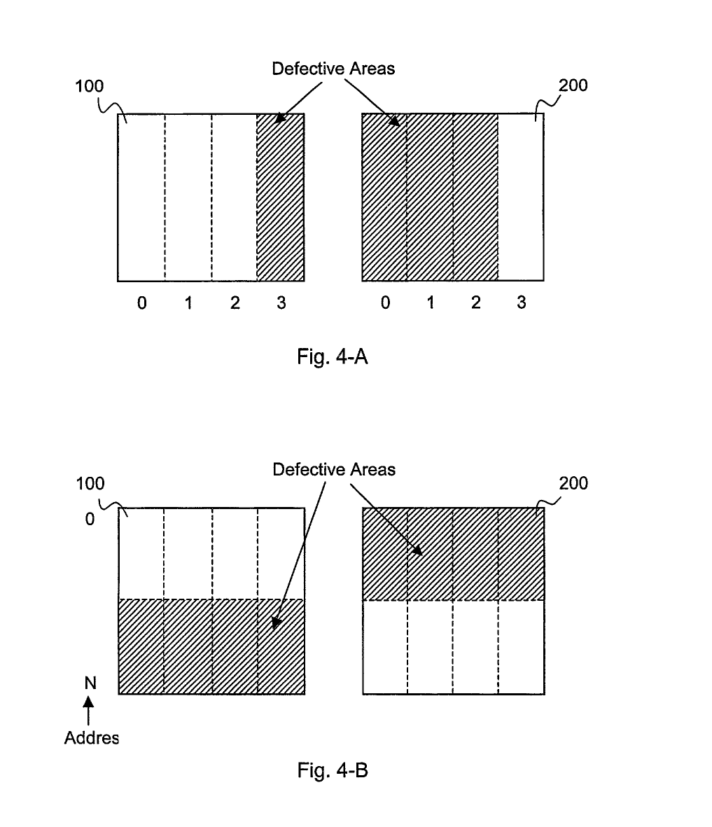

As shown in FIG. 4, there are a first flash memory unit 100, a second flash memory unit 200 and a switching controller 3. The first flash memory unit 100 and the second flash memory unit 200 are of the same brand and model but have symmetric or complementary fault areas. The fault areas can be left-right complementary or top-bottom symmetric.

The switching controller 3 explicitly implements the control circuit to reconfigure the flash memory units for use. In practice, the fault type of the defective areas in the first flash memory unit 100 and the second flash memory unit 200 is recorded in the switching controller 3 via a selection line 40. The symmetric and complementary defective areas that can be processed by the switching controller 3 are first tested and classified before assembling the flash memory modules with the memory module circuit. The fault disorder configuration is recorded in the switching controller 3. Logically, the assembly of the first flash memory unit 100, the second flash memory unit 200 and the switching controller 3 is then considered as a single flash memory unit.

The data line 30 is the data line to the exterior for the entire flash memory unit. It can transmit data and receive commands. If the first flash memory unit 100 and the second flash memory unit 200 are the NAND type flash memory, then the data line 30 can also receive externally input addresses. Since flash memory of different brands or models may have different structures, different reading/writing operations and commands exist. For the switching controller 3 to be applicable to flash memory of different models, the switching controller 3 identifies the flash memory by the model code sent in via the input terminal 70 and thereby determines the data accessing period.

The disclosed method transmits any command, address, data and control signal for the flash memory to the first flash memory unit 100 and the second flash memory unit 200. Before reading out the data, the switching controller 3 reconfigures the first flash memory unit 100 and the second flash memory unit 200 according to the recorded fault area configuration. Data from defective areas is isolated, and correct data from faultless areas is transmitted out via the data line 30.

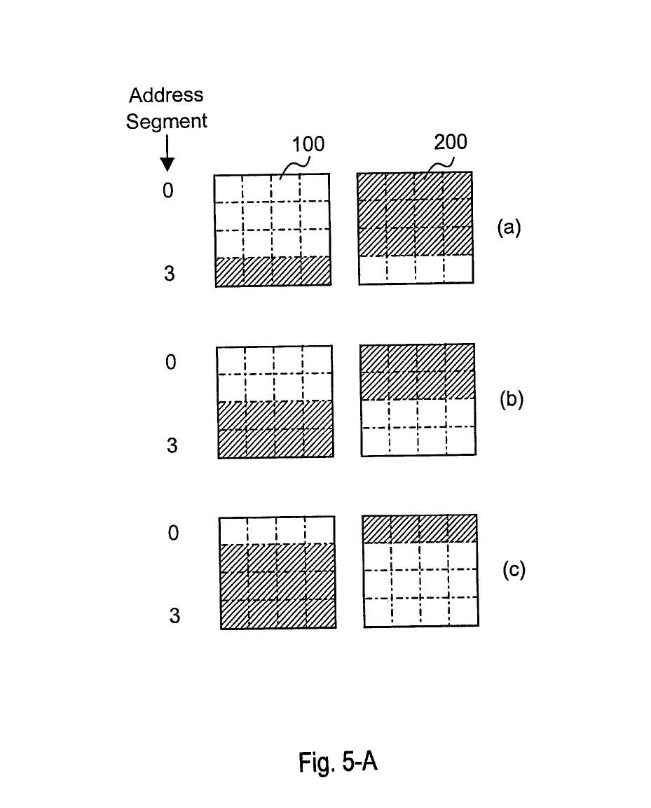

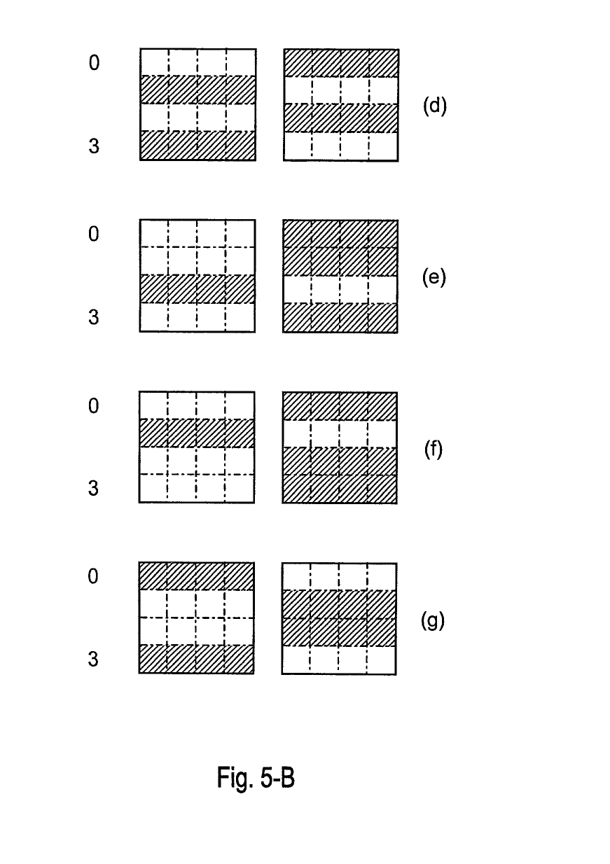

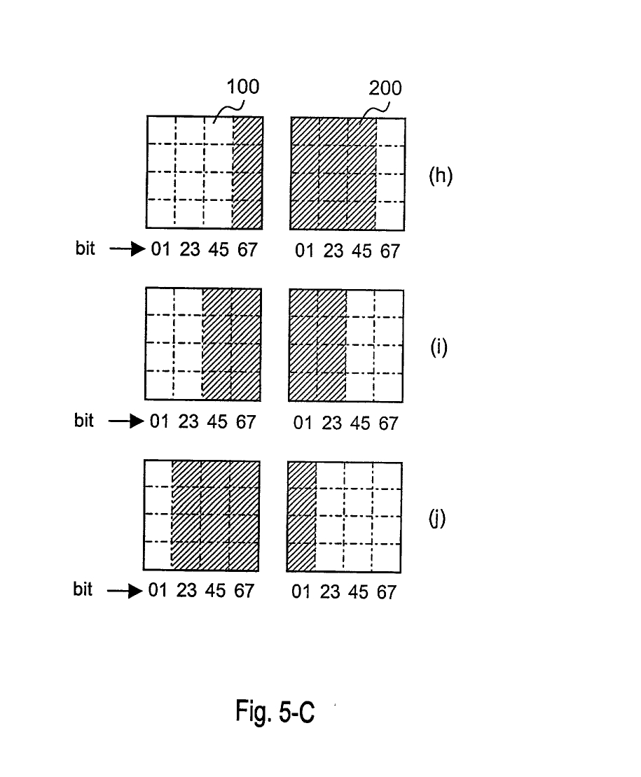

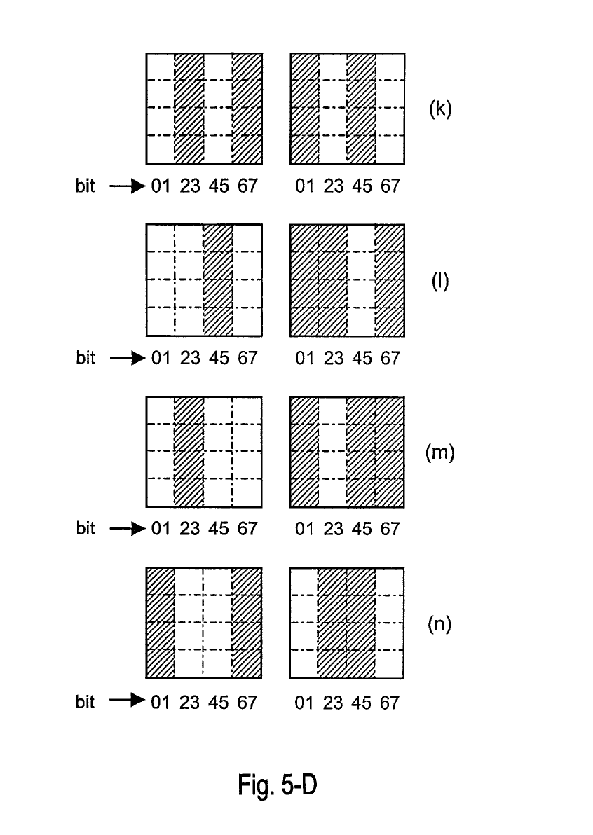

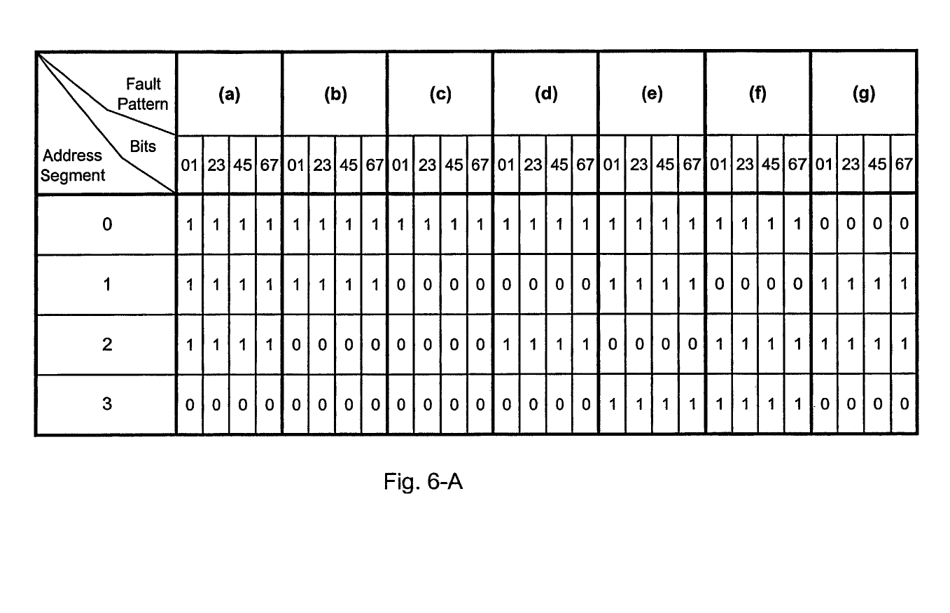

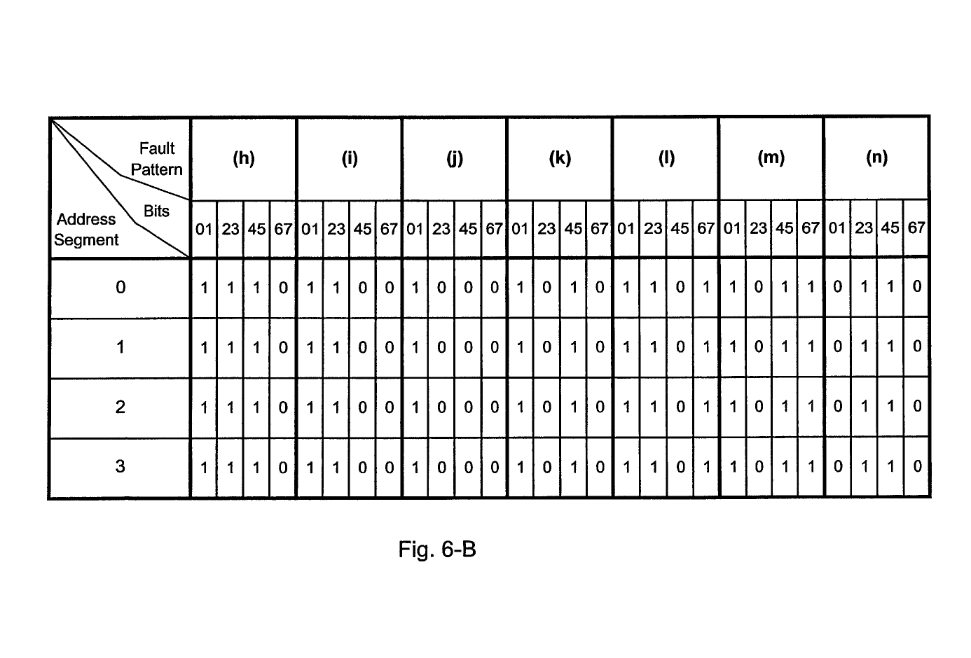

In consideration of the cost for practical applications, the symmetric and complementary defective areas can be limited to specific ranges and configurations. For example, a memory array with 8-bit data output can be divided into 4 columns and 2 rows. That is, each column consists of two bits and each row consists of half memory space. If the defective areas are continuous, one can obtain the four types of symmetric and complementary defective areas in FIGS. 5A through 5D. Therefore, when using flash memory devices with one kind of fault configuration for pairing and reconfiguration, the code of the defective areas have to be stored in the switching controller 3 via the selection line 40. The switching controller 3 can then perform data line switching according to the selection table shown in FIG. 6, to achieve the correct data reconfiguration.

FIG. 6 shows a selection table representing the connection of the first flash memory unit 100 output stored in the switching controller 3, where “1” refers to connection and “0” to disconnection. Therefore, if the defective area is type (c), one should understand from the selection table in FIG. 6 that no matter where data is read out from, the data lines with the bit labels 0, 1, 2, 3, 4, and 5 in the first flash memory unit 100 connect to the corresponding data line 30. The switching controller 3 connects the data lines with the bit label 6 and 7 in the second flash memory unit 200 to the corresponding data lines 30. Such switching can exactly integrate the faultless areas in the first flash memory unit 100 and the second flash memory unit 200 in FIG. 5(c) to provide valid and correct data. Similarly, for the defective areas shown in FIG. 5(a), the reconfiguration of data lines by the switching controller 3 is independent of the bit number but depends upon the address data read out according to the selection table in FIG. 6. If the data being read out is in the upper half memory space (low addresses), then the data line 10 of the first flash memory unit 100 is connected to the data line 30. If the data being read out is in the lower half memory space (high addresses), then the data line 20 of the second flash memory unit 200 is connected to the data line 30. Therefore, only the four configuration types shown in FIG. 5 need to be considered, and the selection line 40 only occupies 2 input pins. In practice, the configuration types of the defective areas can be increased, but, the number of input pins for the selection line 40 have to be increased. In general, if there are K types of fault configurations, the number of input pins H for the selection line 40 must satisfy the following relationship: 2^{H} K>2^{H-1}. The corresponding selection table also changes with the configuration of the defective areas under consideration.

In implementing the entire method, the switching controller plays the key role. Its main functions include successfully transmitting signals for flash memory to the first flash memory unit 100 and the second flash memory unit 200. It switches and reconfigures the defective areas in the flash memory units 100, 200 during the data reading cycle via the data lines 10, 20. The switching controller 3 has to use commands and other control signals to determine the beginning and ending time of the data reading cycle. Once the data reading cycle is determined, it immediately separates the data input connections from the flash memory units 100, 200 so as to avoid incorrect data from reaching the data line 30 through this portion.

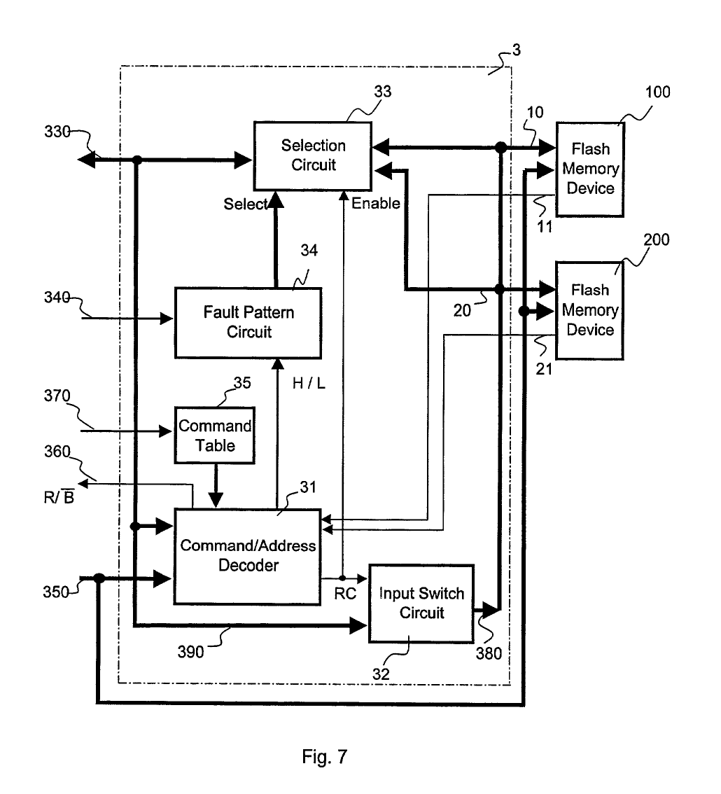

With reference to FIG. 7, a preferred embodiment of the switching controller 3 in accordance with the present invention has a command/address decoder 31, a switch circuit 32, a command table circuit 35, a selection circuit 34, and a switching circuit 33. The switch circuit 32 is directly or indirectly connected to the command/address decoder 31.

The command/address decoder 31 determines the beginning and ending time of a data reading cycle according to the command and address of the input from the data line 30 and the control signal input from a control line 50 and then outputs a reading cycle (RC) signal. If the flash memory is of the NOR type, the address is not entered through the data line but through an independent address line.

The command table circuit 35 enters the product code of the flash memory units 100, 200 through an input line 70. It sends information related to the commands, controls, addresses and data for the flash memory model to the command/address decoder 31 to initiate different decoding functions in the command/address decoder 31. The switching controller 3 can therefore determine the beginning and ending time of data reading in each type of flash memory. Thus, the data lines can be reconfigured to use defective memory units. In particular, the first flash memory unit 100 and the second flash memory unit 200 have to be of the same brand and same model. When the command/address decoder 31 has determined that it is in the Reading Cycle (RC=1), the switching circuit 33 is enabled. The selection circuit 34 uses the switching circuit 33 to select and switch between the data lines 10, 20. The Reading Cycle also uses the switch circuit 32 to separate the external data line 30 and the memory unit data lines 10, 20, preventing the data in the memory unit data lines 10, 20 from feeding back into the external data line 30 through a loop 80, 90.

When it is not in the Reading Cycle (RC=0), the switch circuit 32 is closed while the switching circuit 33 is open so that any input messages on the external data line 30 can be sent to the first and second flash memory units 100, 200 through the connections 80, 90.

When performing data reading/writing, especially under the asynchronous controls, the R/\overline{B}(^{Ready/\overline{Busy}}) output of the flash memory is an important reference for ongoing conditions. Therefore, the R/B output 11 of the first flash memory unit 100 and the ^{R\overline{B}} output 21 of the second flash memory unit 200 are fed back to the command/address decoder 31. After being properly processed by the command/address decoder 31, the R B signal is output via an R B line 60 for other control circuits in the system to use.

The command/address decoder 31 also decodes the address to determine the area where data is read out from and outputs an ^{H/\overline{L}} signal for the selection circuit 34 to make selection controls. The selection circuit 34 makes 2-to-1 multitask selections (such as a 2-to-1 multitask processor) on individual data lines according to the defective areas and data reading addresses of the flash memory units 100, 200 (record fed in via the input line 40) connected to the switching controller 3. The selection method is performed according to the table shown in FIG. 6. In practice, one can further categorize the top-bottom symmetry type. For example, the address space is further divided into four or eight areas. The types of symmetric and complementary defective areas also increase.

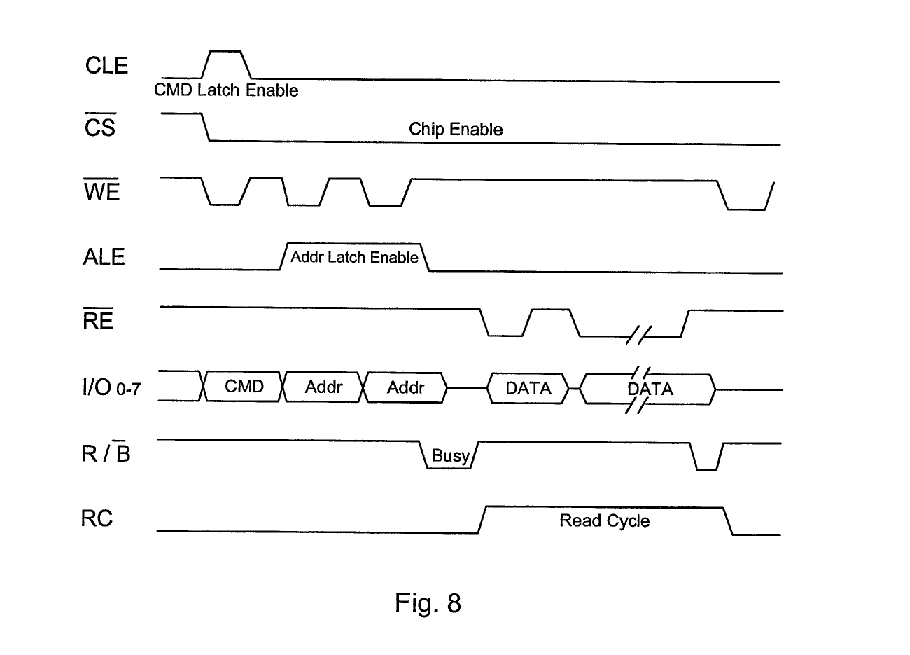

With reference to FIG. 8, in asynchronous control, the command/address decoder 31 extracts commands and addresses from the external data line 30 (I/O_{0˜7}) via the signals CLE, ^{\overline{CS}}, ^{\overline{WE}}, ALE, and ^{\overline{RE}} on the control line 50. It decodes the commands and addresses and determines data reading commands.

^{\overline{CS}} is a chip select signal. When the command/address decoder 31 receives the voltage signal of ^{\overline{CS}} dropping from HIGH to LOW, it then starts to do the decoding. CLE (command latch enable) starts to extract commands from the external data line 30 when the voltage goes from LOW to HIGH. ALE (address latch enable) starts to extract addresses from the external data line 30 when the voltage goes from LOW to HIGH. If the flash memory is of the NOR type, addresses are input through an address line. Therefore, the command/address decoder 31 extracts addresses from the address line. The format and length of the addresses are different for different models of flash memory. If its length is longer than the allowed bits in the external data line 30 (or address line), then it is separated into several inputs. ^{\overline{WE}} determines the time that the data line (or address line) receives commands or addresses each time.

When the flash memory device receives commands and addresses to read data, it reads data from the memory array into an internal register. The flash memory device enters the busy state (^{R/\overline{B}}=0). The data does not appear on the data line yet. When the data is ready to be read in, the voltage of ^{R/\overline{B}} increases from LOW to HIGH. The command/address decoder 31 immediately increases the Reading Cycle RC signal line so as to enable the switching circuit 33. It breaks the connections 80, 90 through the switch circuit 32. The switching/breaking actions continue until the reading period is over and the command/address decoder 31 lowers the RC voltage.

The time-ordered control of asynchronous data reading differs for different types of flash memory. The command/address decoder 31 performs specific command and address decoding depending on the product code input into terminal 70

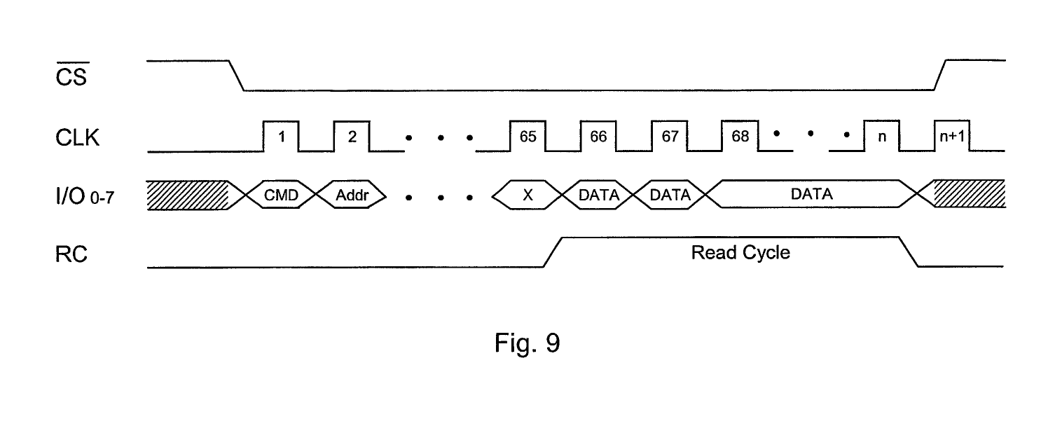

With reference to FIG. 9, in typical synchronous control, the command/address decoder 31 extracts commands and addresses according to the chip select ^{\overline{CS}} and clock pulse CLK signal on the control line 50. Pursuant to the characters of the commands, the command/address decoder 31 uses the clock pulse CLK to do the timing and makes sure the time that subsequent actions occurs. The command/address decoder 31 thus generates the Reading Cycle RC signal to control the actions of the switching circuit 33 and the switch circuit 32. The times that commands and addresses should be entered are completely controlled by the time pulse CLK. Therefore, the command/address decoder 31 initiates different counters depending on the models of the flash memory to control the extraction of commands and addresses.

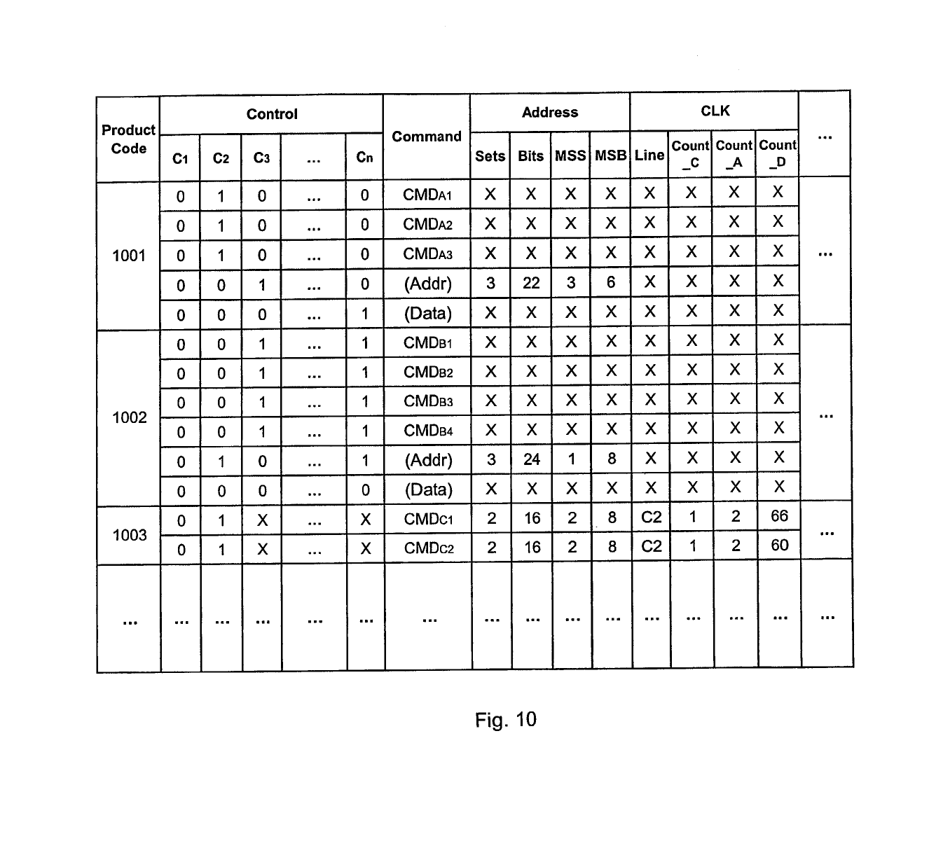

In the example shown in FIG. 10, the model 1001 flash memory has three sets of commands related to data reading, namely, CMDA1, CMDA2, and CMDA3. The indication in the Line column under CLK means that the control is asynchronous.

When the control line 50 has the input C1C2C3 . . . Cn=1 1 0 . . . 0, the command/address decoder 31 extracts commands from the external data line 30. When the control line 50 has the input C1C2C3 . . . Cn=1 0 1 . . . 0, the command/address decoder 31 extracts addresses from the external data line 30 (or address line).

In the command table in FIG. 10, the “Address” column provides information related to addresses. “Sets” refers to the time to input a complete address. “Bits” refers to the number of bits in a complete address. “MSS” refers to which input the highest byte is entered. “MSB” refers to which bit the highest bit shows up in the highest byte. Therefore, in the current example, the address of the flash memory with the product code 1001 totally occupies 22 bits, transmitted in three sets. The highest byte is transmitted first and the highest bit is the sixth bit of the highest byte. When the command/address decoder 31 determines the command as the data reading command and obtains the address according to the above-mentioned method, it can determine the address area and generate an H/L signal for the selection circuit 34 to generate a select signal. On the other hand, when the command/address decoder 31 determines the command as the data reading command and the input on the control line 50 C1C2C3 . . . Cn=1 0 0 . . . 1, the command/address decoder 31 immediately generates RC=1 to turn off the switch circuit 32 and, at the same time, to enable the switching circuit 33, changing to the data flow path. The command/address decoder 31 can determine the length of the data reading cycle (RC=1) based on the commands and addresses.

Taking the flash memory with the product code 1003 as an example, the label C2 in the “Line” column of “CLK” means that the control is a synchronous control. The input C2 of the control line 50 is a clock pulse input. When the input of the control line 50 is C1C2C3 . . . Cn=0 1 0 . . . X, it starts to count the time. “X” here means “Don't care”; that is, its signal value is irrelevant. During the first clock pulse (Count_C=1), the data line 30 has the command input. During the second clock pulse (Count_A=2), the data line 30 (or address line) has the address input. If the command is CMDC1, the data in the flash memory is read out in the 66th clock pulse (Count_D=66). The number of sets of data being read out is determined by the command property and the address after the command. The command/address decoder 31 thereby determines the length of data reading cycle (RC=1). In different models, flash memory has different basic reading/writing units. The difference is also recorded in the command table to determine whether data reading is finished. In practice, the command table can only store the data for a specific model of flash memory to perform data line reconfiguration. In this example, since the command table only needs to store relevant information for data reading for a specific model of flash memory, the switching controller 3 does not need to know the product code through the input terminal 70. When an integrated circuit is used to implement the switching controller 3, fewer connection pins are needed.

Some NAND type flash memory devices have serial in/serial out ports. Commands and addresses enter bit by bit through the serial-in port. Data reading is also bit-by-bit through the serial-out port. The command/address decoder 31 can transmit the commands and addresses to a serial-to-parallel register to extract the commands and addresses. Operations are the same as the parallel input/output of the data line. The switching circuit 33 has to switch to each serial input immediately so as to send them to the serial-out port of the switching controller 3.

In summary, the invention provides a method that reconfigures the data lines of defective flash memory devices so that the defective flash memory can be used. The disclosed method can indeed achieve the expected objectives to use defective flash memory and to lower the production cost. Therefore, the invention has high utility value in industries.

The invention may be varied in many ways by a skilled person in the art. Such variations are not to be regarded as a departure from the spirit and scope of the invention, and all such modifications are intended to be included within the scope of the following claims. For example, EEPROM or other nonvolatile semiconductor memory can achieve the same objectives following the spirit of the invention.

What is claimed is:

1. A method that reconfigures a set of flash memory units with complementary fault areas, reconfigures data lines during a data reading cycle to isolate data from fault areas, integrates data stored in faultless areas into a complete set of data for output, and directly controls each faulted flash memory to perform various operations during periods other than the data reading cycle.

2. The method of claim 1, wherein the set of flash memory refers to two or more than two flash memory devices.

3. The method of claim 1, wherein the symmetric and complementary fault areas means that the fault areas in the memory array for data storage in the set of flash memory units are symmetric and complementary or are complementary to each other, any of the flash memory devices with the fault areas having at least one faultless area so that when the flash memory device is integrated for use, the faultless data storage area can be used in complement, providing the reading/writing functions of normal flash memory of the same model.

4. The method of claim 1, wherein the commands and control signals given by the flash memory are generated by an external control circuit, whereby the data reading cycle can be determined to control the data flow in the data line, the signals in the data line being limited to flow from the flash memory to the external control circuit during the data reading cycle but from the external control circuit to the flash memory during other times.

5. The method of claim 4, wherein the data line output of a set of flash memory units with symmetric and complementary fault areas is reconfigured so as to integrate data stored in faultless areas into a correct data output, while allowing the external control circuit to give commands or perform data writing to each of the flash memory units through the data line during other time periods.

6. A switching control circuit to reconfigure flash memory to remove faults, perform data line reconfiguration of the flash memory during a data reading cycle and allow an external control circuit to perform command giving/data writing through a data line, the switching control circuit comprising:
a command/address decoder, which intercepts the commands, addresses and control signals given by the external control circuit to the flash memory so as to determine the beginning and ending time of a data reading cycle, identifies the section of the input address, and outputs to the identified address;
a switch circuit, which enters the commands, addresses and data into the flash memory unit through the data line during the non-data reading cycle but prevents data from flowing through the circuit backwards during the data reading cycle;
a switching circuit, which performs multitask selections to a set of flash memory units with symmetric and complementary or complementary fault areas during the data reading cycle to reconfigure the data line output and integrates the data into a complete data set to be output to an external controller;
a selection circuit, which generate a selection signal for the switching circuit to perform the multitask selection depending on the configuration type of the set of flash memory and the input address transmitted from the command/address decoder; and
a command table circuit, which receives the product code of the flash memory and transmit information relating to the controls, commands, addresses and data for the flash memory with the product code to the command/address decoder for decoding the commands and addresses for the flash memory of the specific product code.

7. The circuit of claim 6, wherein the circuit structure of the switch circuit, the switching circuit and the selection circuit depend upon the number of flash memory units used.

8. The circuit of claim 6, wherein the switching control circuit is applicable to flash memory of different brands and models for performing flash memory reconfiguration and fault removal.

9. The circuit of claim 6, wherein the command table circuit transmits in accordance with the product code of the flash memory information relating to the controls, commands, addresses and data for the flash memory with a particular product code in the command table to the command/address decoder for command and address decoding.

10. The circuit of claim 9, wherein the command table of the command table circuit incorporates information about the controls, commands, addresses and data for several types of flash memory into a character table so that the circuit can reconfigure the flash memory of different brands and models.

11. The circuit of claim 9, wherein the command/address decoder can decode commands, addresses and control signals according to the controls, commands, addresses and data relating to flash memory with a product code provided by the command table circuit so as to determine the beginning and ending time of the data reading cycle and the address for reading data.

12. The circuit of claim 10, wherein the command/address decoder can decode commands, addresses and control signals according to the controls, commands, addresses and data relating to flash memory with a product code provided by the command table circuit so as to determine the beginning and ending time of the data reading cycle and the address for reading data.
